(19) United States
(12) Patent Application Publication
(10) Pub. No.: US 2020/0320156 A1
(43) Pub. Date: Oct. 8, 2020

(54) WEB PAGE DISPLAY METHOD, BROWSER, TERMINAL, AND COMPUTER-READABLE STORAGE MEDIUM

(71) Applicant: ZTE CORPORATION, Shenzhen, Guangdong (CN)

(72) Inventor: Gang CAO, Shenzhen, Guangdong (CN)

(21) Appl. No.: 16/765,518

(22) PCT Filed: Dec. 3, 2018
(86) PCT No.: PCT/CN2018/118947

§ 371 Date: May 20, 2020

(30) Foreign Application Priority Data
Dec. 5, 2017 (CN) 201711270394.2

(51) Int. Cl. G06F 16/957; G06F 16/958; G06F 40/14

(52) U.S. Cl. CPC G06F 16/9577; G06F 40/14; G06F 16/986

(57) ABSTRACT

The present disclosure provides a web page display method, a browser, a terminal, and a computer-readable storage medium. The web page display method includes: generating, when a first web page contains a preset element, a second web page according to the first web page, the second web page containing all elements of the first web page, and a positioning attribute of a region in the second web page where the preset element is located being fixed relative to a browser window; and displaying the second web page.

### TECHNICAL FIELD

The present disclosure relates to, but is not limited to, network technologies.

### BACKGROUND

With rapid development and popularization of the 4G wireless communication technology, more and more users have been used to browsing web pages on mobile terminals. However, a user may encounter a scenario that, when scrolling through a web page, the user cannot simultaneously browse contents on an upper portion of the web page while browsing contents on a lower portion of the web page. For example, when the web page includes a video, the user may browse other information in the web page below the video, which may result in that the video cannot be played.

### SUMMARY

At least one embodiment of the present disclosure provides a web page display method, a browser, a terminal, and a computer-readable storage medium which enable browsing different elements in a web page at the same time.

At least one embodiment of the present disclosure provides a web page display method, including: generating, when a first web page contains a preset element, a second web page according to the first web page, the second web page containing all elements of the first web page, and a positioning attribute of a region in the second web page where the preset element is located being fixed relative to a browser window; and displaying the second web page.

In an embodiment of the present disclosure, there is provided a browser, including: a main control module, a detection module, and a reconstruction module, wherein the main control module is configured to call the detection module so that the detection module detects whether a preset element is present in a first web page, and to call the reconstruction module upon receiving a detection result returned from the detection module indicating presence of the preset element in the first web page, so that the reconstruction module generates and displays a second web page according to the first web page; the detection module is configured to detect whether the preset element is present in the first web page, and return the detection result to the main control module; and the reconstruction module is configured to generate the second web page according to the first web page, the second web page containing all elements of the first web page, and a positioning attribute of a region in the second web page where the preset element is located being fixed relative to a browser window.

In an embodiment of the present disclosure, there is provided a terminal, including a memory and a processor, the memory having a computer program stored thereon which, when read and executed by the processor, causes the processor to implement the web page display method of the present disclosure.

In an embodiment of the present disclosure, there is provided a computer-readable storage medium having one or more programs stored thereon which is executable by one or more processors to cause the web page display method of the present disclosure to be implemented.

Other features and advantages of the disclosure will be set forth in the description which follows, and will become apparent from the description at least partially, or be understood by implementing the disclosure. Objects and other advantages of the disclosure may be realized and obtained by means of the structures particularly pointed out in the description, appended claims and drawings.

### BRIEF DESCRIPTION OF THE DRAWINGS

Accompanying drawings are provided for further understanding of the technical solution of the disclosure and constitute a part of the specification. Hereinafter, these drawings are intended to explain the technical solution of the disclosure together with the following embodiments, but should not be considered as a limitation to the technical solution of the disclosure. In the drawings:

FIG. 1 is a flowchart of a web page display method according to an embodiment of the present disclosure;

FIG. 2 is a flowchart of a web page display method according to another embodiment of the present disclosure;

FIG. 3 is a flowchart of a web page reconstruction method according to an embodiment of the present disclosure;

FIG. 4A is a schematic diagram of a Document Object Model (DOM) tree according to an embodiment of the present disclosure;

FIG. 4B is a schematic diagram of a reconstructed DOM tree according to another embodiment of the present disclosure;

FIG. 4C is a schematic diagram of a reconstructed DOM tree according to another embodiment of the present disclosure;

FIG. 5 is a schematic diagram showing a layout of a web page reconstructed by the web page display method according to an embodiment of the present disclosure;

FIG. 6 is a block diagram of a browser according to an embodiment of the present disclosure; and

FIG. 7 is a block diagram of a terminal according to an embodiment of the disclosure.

### DETAILED DESCRIPTION

For clarity and better understanding of the objects, technical solution and advantages of the disclosure, embodiments of the disclosure will now be described in detail in conjunction with the accompanying drawings. It should be noted that the embodiments of the disclosure and features herein may be combined with each other in any manner as long as they are not contradictory.

The steps illustrated in the flowchart of the drawings may be executed in a computer system such as a set of computer executable instructions. Also, although a logical order is shown in the flowchart, in some cases, the steps shown or described may be performed in a different order than illustrated herein.

In the related art, there are two main solutions enabling simultaneously viewing of video and non-video elements in the same browser.

The browser Chrome of Google Corporation uses a technique for controlling playing of a levitated video. The method mainly involves downloading a plug-in called Video Tape onto a browser, which can help a user to fix a position and a size of a video. After installing the plug-in Video Tape in Chrome, a user can achieve a purpose such as a video patch. While the video is playing, it will not be affected by the user pulling a scroll bar. A main defect of this method is that an independent player plug-in needs to be downloaded, which has certain requirements on the compatibility of the system while affecting traffic and storage space of the user.

Qihoo Corporation proposes a method that eliminates the need for plug-ins by, after injecting a control script into the web page, constantly detecting whether a video element is partially or completely invisible when a scroll bar of a browser is moved, and then readjusting the video element to a visible position. This method is simpler than the former one, but due to the constant detection and movement operations, it tends to cause problems such as flashing display of the web page and higher power consumption of the browser.

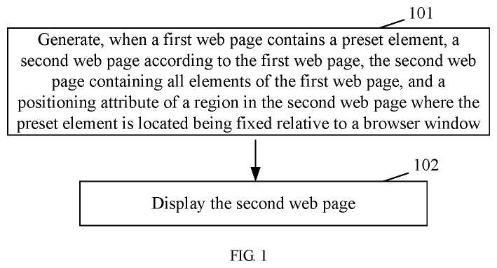

In an embodiment of the present disclosure, there is provided a web page display method which, as shown in FIG. 1, includes steps 101 and 102.

At step 101, when a first web page contains a preset element, a second web page is generated according to the first web page, the second web page containing all elements of the first web page, and a positioning attribute of a region in the second web page where the preset element is located being fixed relative to a browser window.

At step 102, the second web page is displayed.

According to the web page display method provided in the embodiment of the present disclosure, a position of the region where the preset element is located is fixed relative to the browser window, and when the scroll bar of the web page is pulled, the preset element is still displayed at the fixed position and will not be changed along with the scroll bar so that a user can browse the preset element while browsing other elements in the web page. Compared with the related art, the web page display method provided in the embodiment does not need to download an independent player plug-in, or affect traffic and storage space of the user. In addition, there is no need to judge and move a current position of the preset element frequently to avoid the defects in power consumption and flashing display.

In an embodiment, the preset element is a video element. At this time, according to the web page display method of the present disclosure, other elements in the web page can be viewed while the video is watched, and playing of the video is not affected even when a scroll bar is pulled (the position of the video element is fixed). It should be noted that the preset element is not limited to a video element, and may also be other elements such as a picture and the like.

In an embodiment, when a second web page is generated according to the first web page, a positioning attribute of a region in the first web page where the preset element is located may be modified to be fixed relative to the browser window so that the modified first web page serves as the second web page. For example, a positioning attribute of a parent node of the child node corresponding to the video element in the Document Object Model (DOM) tree of the first web page may be modified to be fixed relative to the browser window. A Cascading Style Sheet (CSS) is used to define how elements in a web page are displayed. The position of the element may be set by a Positioning attribute of the CSS. The Positioning attribute generally includes four types: Static, Relative, Absolute and Fixed, wherein Fixed means that a position of an element is fixed relative to the browser window, i.e., the element has a fixed position in the browser window. Therefore, the positioning attribute of the region where the video element is located may be set to Fixed.

In another embodiment, the first web page may be reconstructed to generate the second web page, i.e., positions of various elements in the first web page are adjusted so that the video element is extracted and separately placed in a region, while other elements in the first web page are placed in another region.

DOM defines objects and attributes of all the web page elements. All contents in the web page are nodes, where the whole document is a document node, each element is an element node, and all the elements in the web page form a DOM tree with a top end node called root node, the root node having multiple levels of child nodes.

Specifically, the step of generating the second web page according to the first web page may include: acquiring a root node of a first DOM tree of the first web page to serve as a root node of a second DOM tree of the second web page; creating a first element label and a second element label, and respectively taking the first element label and the second element label as child nodes of the root node of the second DOM tree; setting a positioning attribute of the first element label to be fixed relative to a browser window; extracting a child node corresponding to the preset element in the first DOM tree to serve as a child node of the first element label; and extracting other child nodes except the root node and the child node corresponding to the preset element in the first DOM tree and placing the other child nodes under the second element label according to a structure thereof in the first DOM tree.

In other embodiments, the other child nodes except the root node and the child node corresponding to the preset element in the first DOM tree may be placed under the root node of the second DOM tree according to a structure thereof in the first DOM tree without creating the second element label.

In other embodiments, the region corresponding to the first element label and the region corresponding to the second element label may each occupy half of the browser window. For example, the region corresponding to the first element label occupies an upper half of the browser window, and the region corresponding to the second element label occupies a lower half of the browser window. Apparently, other ratios may be set as needed. For example, the region corresponding to the first element label may occupy one third of the browser window, the region corresponding to the second element label may occupy two thirds of the browser window, and so on.

Elements in a web page may be divided into block-level elements and inline elements. The block-level elements are represented in blocks, may accommodate the inline elements and other block-level elements, and may be set in height, width, and so on. The inline elements do not occupy separate space but is attached to the block-level elements. The first element label may be a block-level element such as a DIV label, an hl label, a section label, an area label, and the like. The second element label may be a block-level element or an embedded web page label, i.e., an IFRAME label. The IFRAME label is used for displaying another web page within a web page. When the second element label is an IFRAME label, a user may redirect to another web page during browsing without affecting the content displayed in the region corresponding to the first element label. For example, when a video is playing in the region corresponding to the first element label, a display content in the region corresponding to the second element label is changed when a link in the region corresponding to the second element label is clicked (the content corresponding to the link is displayed), but the video in the region corresponding to the first element label is still played so that the user can conveniently browse the web page while watching the video. It should be noted that the first element label may also be an IFRAME label.

In this embodiment, the child nodes of the second element label do not include the child node corresponding to the preset element. In other embodiments, the child nodes of the second element label may include the child node corresponding to the preset element. In addition, the child nodes of the first element label may further include other child nodes except the child node corresponding to the preset element. That is, the video, as well as part of the non-video elements, may be displayed in the region corresponding to the first element label.

In an embodiment, the step of generating the second web page according to the first web page may include: acquiring a layout height of the first web page, and judging whether the layout height of the first web page exceeds a height of a terminal screen for displaying the first web page; generating the second web page according to the first web page when the layout height of the first web page exceeds the height of the terminal screen for displaying the first web page; and directly displaying the first web page in a case that the layout height of the first web page is less than or equal to the height of the terminal screen.

The layout height of the web page refers to a total height of the web page, i.e. a total height of all the contents contained in the web page. The layout height of the web page is not necessarily a height of a web page currently displayed in the browser window (i.e., the browser window does not display the entire web page), but rather an overall height of the web page. In a case that not all the contents of the first web page can be displayed within the height of the terminal screen, the first web page is processed by the solution of the disclosure; and in a case that all the contents of the first web page can be displayed within the height of the terminal screen, the first web page is not processed.

In other embodiments, the step of generating the second web page according to the first web page may be always performed without judging the layout height of the first web page, that is, the second web page is generated regardless of whether the layout height of the first web page exceeds the screen height. For example, although the layout height of the first web page is less than the height of the terminal screen, the user's requirements of browsing and redirecting the web page while watching the video can still be satisfied by the solution of the present disclosure.

In an embodiment, the display method may further include: displaying elements in a region corresponding to the second element label in a scrolling manner at a preset speed. That is, the user does not need to manually pull the scroll bar, and the content in the region corresponding to the second element label is automatically scrolled and displayed. The scrolling display may be implemented by a scroll bar timer. In other embodiments, the scroll bar may be pulled by the user himself/herself for browsing. The preset speed may be set in advance, such as to an average reading speed of an ordinary person.

The present disclosure is further described below by taking the preset element being a video element as an example, and when the preset element is another type of element, the implementation manner is similar and details are not repeated here.

According to the web page display method provided in the embodiment of the present disclosure, when a web page is opened and a video element is detected, the browser reconstructs the DOM tree structure of the web page. The new DOM tree structure is divided into two parts: one is a first region with a DIV label as the main node and containing the original video element of the web page; the other is a second region with an IFRAME label as the main node and containing the original non-video elements of the web page. In this manner, a user can scroll through other non-video elements (such as texts, pictures and the like) while watching video contents, thereby improving the user experience without affecting the compatibility, power consumption, traffic and storage adversely.

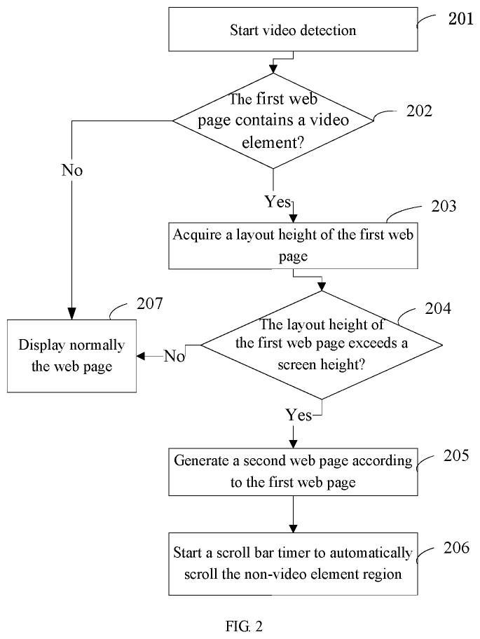

As shown in FIG. 2, in an embodiment of the present disclosure, there is provided a web page display method including steps 201 to 207.

At step 201, elements contained in a first web page are detected upon or before opening the first web page.

At step 202, it is judged whether the first web page contains a video element; proceed to step 203 in a case that the first web page contains a video element, and proceed to step 207 in a case that a video element is not contained.

At step 203, a layout height of the first web page is acquired.

At step 204, it is judged whether the layout height of the first web page exceeds a screen height; proceed to step 205 in a case of exceeding the screen height, and proceed to step 207 in a case of not exceeding the screen height.

At step 205, a second web page is generated according to the first web page, the second web page containing all elements of the first web page, and a positioning attribute of a region in the second web page where the preset element is located being fixed relative to a browser window.

At step 206, a scroll bar timer is started to scroll the non-video element content up and down repeatedly at a preset speed. The preset speed may be an average reading speed of an ordinary person, but apparently, may also be set to other values.

It should be noted that in other embodiments, step 206 may not be performed, and the user may manually pull the scroll bar to browse. The scroll bar may be omitted in case of a small layout height of the web page.

At step 207, processing is performed by displaying normally the web page.

In this embodiment, by setting the positioning attribute of the region where the video element is located to be fixed relative to the browser window so that the position of the video element remains unchanged, the position of the video element will not be affected even if a user drags the scroll bar, thereby realizing watching the video while browsing the web page at the same time. According to the solution of the embodiment, the need of downloading a new plug-in is eliminated, the compatibility, power consumption, traffic and storage of the system are not affected, and there is no need to judge and move a current position of the video frequently, thereby avoiding the defects in power consumption and flashing display.

FIG. 3 is a flowchart of a web page reconstruction method according to an embodiment of the present disclosure. As shown in FIG. 3, the method includes steps 301 to 306.

At step 301, a root node (denoted as R1) of the DOM tree of the first web page is taken as a root node (denoted as R0) of the DOM tree of the second web page.

At step 302, a DIV label (denoted as D1) and an IFRAME label (denoted as IF1) are respectively created as child nodes to be inserted under the root node R0.

At step 303, CSS attributes of D1 and IF1 are respectively set.

CSS is used to define how elements in a web page are displayed, such as background of the elements, fonts of the text, colors, border sizes, positions, etc., which can be set as needed. The positioning attribute of D1 is set to be fixed relative to the browser window, i.e., the positioning attribute of D1 is set to Fixed.

In this embodiment, the following attributes may be set for D1 and IF1: 100% in width and 50% in height so that D1 and IF1 each occupy half in a screen height direction. Apparently, this is merely an example and other ratios may be set as needed, such as D1 occupying ⅓ of the screen, and IF1 occupying ⅔ of the screen, and so on.

At step 304, a video node (denoted as V1) in the DOM tree of the first web page is extracted to be inserted as a child node under the D1 label.

At step 305, other child nodes (denoted as S1, S2 . . . ) under the root node of the DOM tree of the first web page are taken as child nodes to be inserted under the IF1 label.

At step 306, the DOM tree R0 of the second web page is rendered and displayed.

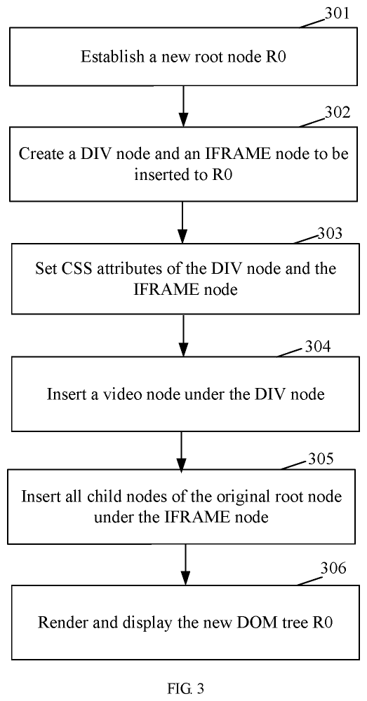

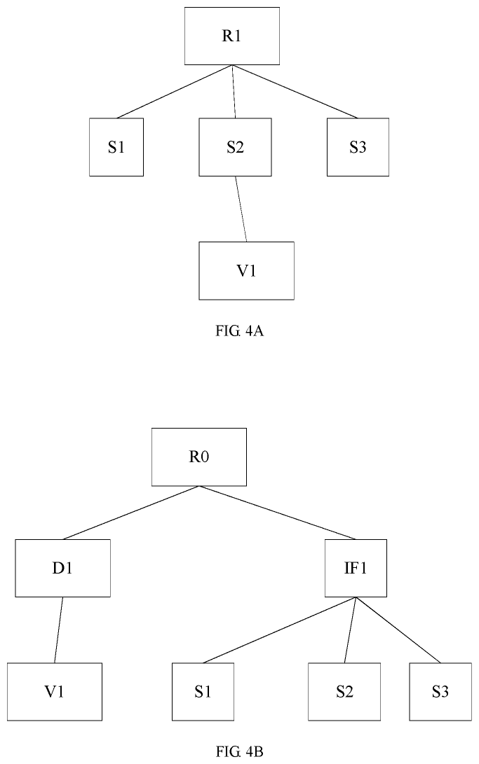

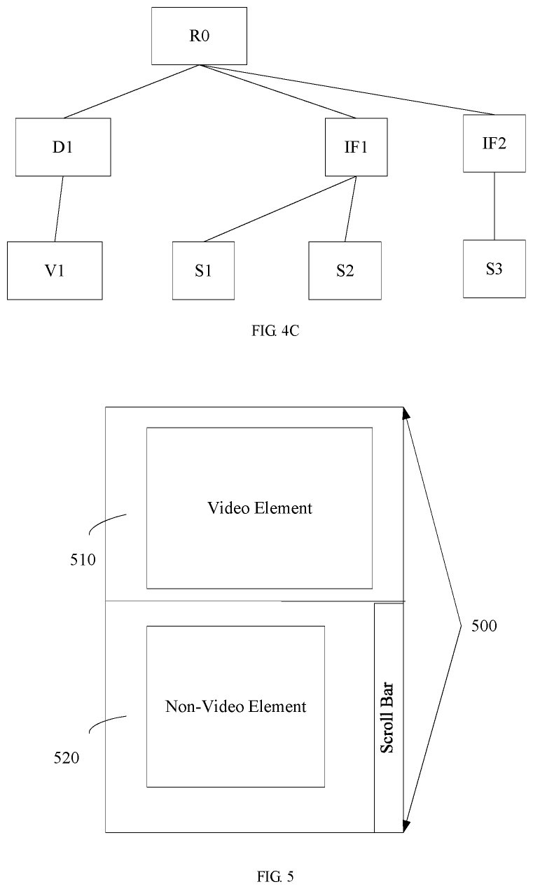

The reconstruction of the DOM tree is described by taking the DOM tree shown in FIG. 4A as an example. FIG. 4A is a schematic diagram of the first DOM tree of the first web page. As shown in FIG. 4A, the root node R1 of the first DOM tree includes three child nodes, S1, S2 and S3, and the child node S2 further includes a child node V1 corresponding to a video element. Reconstructing the first DOM tree includes: extracting the root node R1 of the first DOM tree as a root node R0 of the second DOM tree; establishing a first element label D1 as a child node of R0, and extracting a child node V1 corresponding to the video element from the first DOM tree as a child node of the first element label D1; and establishing a second element label IF1 (an IFRAME label in the present embodiment) as a child node of R0, and extracting other child nodes except the root node R1 and the child node V1 corresponding to the video element from the first DOM tree and placing the other child nodes under the second element label IF1 according to an original structure thereof, so as to obtain a second DOM tree as shown in FIG. 4B. In other embodiments, the structure of each child node under the second element label IF1 may be different from that in the first DOM tree, i.e., may be reset.

According to the present embodiment, the user can, while watching the video in the region corresponding to the first element label D1, browse the web content in the region corresponding to the second element label IF1 without affecting the playing of the video. In addition, because the second element label IF1 is an IFRAME label, the user can, while watching the video, redirect to browse another web page without affecting the playing of the current video, thereby greatly improving the use experience of enjoying a web page with videos by the browser.

In another embodiment, reconstructing the DOM tree shown in FIG. 4A in another manner includes: extracting the root node R1 of the first DOM tree as a root node R0 of the second DOM tree; establishing a first element label D1 as a child node of R0, and extracting a child node V1 corresponding to the video element from the first DOM tree as a child node of D1; establishing a second element label IF1 (an IFRAME label in the present embodiment) as a child node of R0, and extracting child nodes S1 and S2 from the first DOM tree to place under IF1; and establishing a third element label IF2 (an IFRAME label in the present embodiment) as a child node of R0, and extracting a child node S3 from the first DOM tree to place under IF2, so as to obtain a second DOM tree as shown in FIG. 4C. Three regions are obtained on the screen after the DOM tree is rendered and displayed, that is, a first region corresponding to the first element label D1, a second region corresponding to the second element label IF1, and a third region corresponding to the third element label IF2.

FIG. 5 is a schematic diagram of a web page layout interface displayed by a browser after the web page is reconstructed according to an embodiment of the present disclosure. As shown in FIG. 5, a terminal screen 500 is subdivided into two parts in a vertical direction: a first region 510, which is a region corresponding to a first element label (a DIV label in this embodiment) for displaying a video element, and has a fixed position relative to the browser window; and a second region 520, which is a region corresponding to a second element label (an IFRAME label in this embodiment) for displaying contents of other non-video elements (such as texts, pictures, links, etc.). A scroll bar in the second region 520 may be controlled automatically or manually. Additionally, when a user clicks on a link in the second region 520, a new web page may be opened in the second region 520 without affecting the continued display of the video in the first region 510.

The solution of the present disclosure eliminates the need of downloading an independent player plug-in which may increase traffic of the user. In addition, compared with the mode of detecting whether a video element is partially or completely invisible and then readjusting the video element to a visible position in the related art, the solution of the present disclosure fixes the position of the video element by setting the positioning attribute for fixing the video element, eliminates the need of detecting and adjusting the position of the video element frequently, and thus is relatively low in power consumption. Therefore, the present disclosure can greatly improve the user experience of watching videos through a browser without increasing the traffic of the user and the power consumption. It should be noted that the layout of the first region and the second region shown in FIG. 5 is only an example, and may be adjusted as needed. For example, the height of the first region may be reduced while the height of the second region may be increased, and so on. Additionally, in other embodiments, three regions, i.e., a first region, a second region, and a third region, may also be established if needed. The first region displays a video element in the original web page, the second region displays part of the non-video elements in the original web page, and the third region displays the rest non-video elements in the original web page. Apparently, the second and third regions may display the same content. In addition, a function button for web page adjustment may be provided on the page, or a setting function regarding whether to adjust the web page may be provided in the system. When a user selects the function button or sets to adjust, the web page is displayed after being adjusted according to the solution of the present disclosure. When the user cancels the function button or set to not adjust, the web page is displayed normally.

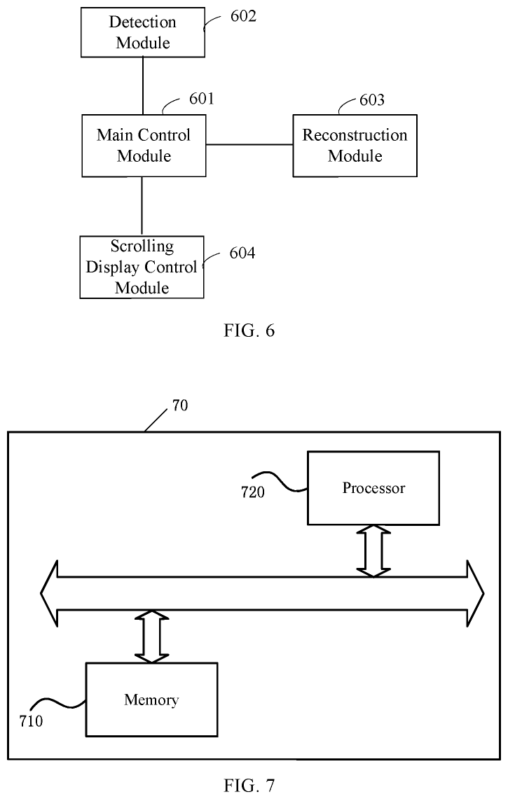

As shown in FIG. 6, in an embodiment of the present disclosure, there is provided a browser, including: a main control module 601, a detection module 602, and a reconstruction module 603.

The main control module 601 is configured to call the detection module 602 so that the detection module 602 detects whether a preset element is present in a first web page, and to call the reconstruction module 603 upon receiving a detection result returned from the detection module 602 indicating presence of the preset element in the first web page, so that the reconstruction module 603 generates and displays a second web page according to the first web page.

The detection module 602 is configured to detect whether the preset element is present in the first web page, and return the detection result to the main control module 601.

The reconstruction module 603 is configured to generate the second web page according to the first web page, the second web page containing all elements of the first web page, and a positioning attribute of a region in the second web page where the preset element is located being fixed relative to a browser window.

In an embodiment, the reconstruction module 603 is configured to: acquire a root node of a first DOM tree of the first web page to serve as a root node of a second DOM tree of the second web page; create a first element label and a second element label, and respectively take the first element label and the second element label as child nodes of the root node of the second DOM tree; set a positioning attribute of the first element label to be fixed relative to a browser window; extract a child node corresponding to the preset element in the first DOM tree to serve as a child node of the first element label; and extract other child nodes except the root node and the child node corresponding to the preset element in the first DOM tree and place the other child nodes under the second element label according to a structure thereof in the first DOM tree.

In an embodiment, the detection module 602 is further configured to acquire a layout height of the first web page, judge whether the layout height of the first web page exceeds a height of a terminal screen for displaying the first web page, and return a judgment result to the main control module 601.

Under a condition that detection result returned from the detection module 602 indicating presence of the preset element in the first web page, and that the layout height of the first web page exceeds the height of the terminal screen for displaying the first web page, the main control module 601 calls the reconstruction module 603 so that the reconstruction module 603 generates and displays the second web page according to the first web page.

In an embodiment, the browser further includes a scrolling display control module 604 configured to display elements in a region corresponding to the second element label in a scrolling manner at a preset speed.

As shown in FIG. 7, in an embodiment of the present disclosure, there is provided a terminal 70 including a memory 710 and a processor 720. The memory 710 has a program stored thereon which, when read and executed by the processor 720, causes the processor 720 to implement the web page display method of the various embodiments the present disclosure.

In an embodiment of the present disclosure, there is provided a computer-readable storage medium having one or more programs stored thereon which is executable by one or more processors to cause the web page display method of any of the above embodiments to be implemented.

The computer-readable storage medium includes: a U Disk, a read-only memory (ROM), a random access memory (RAM), a mobile hard disk, a disk or optical disk, and other media that can store a program code.

Despite the implementations disclosed in the present disclosure as described above, they are merely implementations used to facilitate the understanding of the present disclosure, and are not intended to limit the present disclosure. Any modification and variation in the form and details of the embodiments can be made by any person skilled in the art of the present disclosure without departing from the spirit and scope disclosed by the disclosure. However, the scope of protection of the disclosure is defined by the scope of the appended claims.

1. A web page display method, comprising:
generating, when a first web page contains a preset element, a second web page according to the first web page, the second web page containing all elements of the first web page, and a positioning attribute of a region in the second web page where the preset element is located being fixed relative to a browser window; and
displaying the second web page.

2. The web page display method according to claim 1, wherein the preset element is a video element.

3. The web page display method according to claim 1, wherein the step of generating the second web page according to the first web page comprises:
acquiring a layout height of the first web page; and
judging whether the layout height of the first web page exceeds a height of a terminal screen for displaying the first web page, and generating the second web page according to the first web page in response to that the layout height of the first web page exceeds the height of the terminal screen for displaying the first web page.

4. The web page display method according to claim 1, wherein the step of generating the second web page according to the first web page comprises:
acquiring a root node of a first Document Object Model tree of the first web page to serve as a root node of a second Document Object Model tree of the second web page;
creating a first element label and a second element label, and respectively taking the first element label and the second element label as child nodes of the root node of the second Document Object Model tree;
setting a positioning attribute of the first element label to be fixed relative to a browser window;
extracting a child node corresponding to the preset element in the first Document Object Model tree to serve as a child node of the first element label; and
extracting other child nodes except the root node and the child node corresponding to the preset element in the first Document Object Model tree and placing the other child nodes under the second element label according to a structure thereof in the first Document Object Model tree.

5. The web page display method according to claim 4, wherein the second element label is an embedded web page label.

6. The web page display method according to claim 4, further comprising:
displaying elements in a region corresponding to the second element label in a scrolling manner at a preset speed.

7. A browser comprising a main control module, a detection module and a reconstruction module, wherein
the main control module is configured to call the detection module so that the detection module detects whether a preset element is present in a first web page, and to call the reconstruction module upon receiving a detection result returned from the detection module indicating presence of the preset element in the first web page, so that the reconstruction module generates and displays a second web page according to the first web page;
the detection module is configured to detect whether the preset element is present in the first web page, and return the detection result to the main control module; and
the reconstruction module is configured to generate the second web page according to the first web page, the second web page containing all elements of the first web page, and a positioning attribute of a region in the second web page where the preset element is located being fixed relative to a browser window.

8. The browser according to claim 7, wherein the preset element is a video element.

9. The browser according to claim 7, wherein the detection module is further configured to:
acquire a layout height of the first web page; and
judge whether the layout height of the first web page exceeds a height of a terminal screen for displaying the first web page, and return a judgment result to the main control module, and
in response to the detection result returned from the detection module indicating presence of the preset element in the first web page and that the layout height of the first web page exceeds the height of the terminal screen for displaying the first web page, the main control module calls the reconstruction module so that the reconstruction module generates the second web page according to the first web page.

10. The browser according to claim 7, wherein the reconstruction module is configured to:
acquire a root node of a first Document Object Model tree of the first web page to serve as a root node of a second Document Object Model tree of the second web page;
create a first element label and a second element label, and respectively take the first element label and the second element label as child nodes of the root node of the second Document Object Model tree;
set a positioning attribute of the first element label to be fixed relative to a browser window;
extract a child node corresponding to the preset element in the first Document Object Model tree to serve as a child node of the first element label; and
extract other child nodes except the root node and the child node corresponding to the preset element in the first Document Object Model tree and place the other child nodes under the second element label according to a structure thereof in the first Document Object Model tree.

11. The browser according to claim 10, wherein the second element label is an embedded web page label.

12. The browser according to claim 10, further comprising:
a scrolling display control module configured to display elements in a region corresponding to the second element label in a scrolling manner at a preset speed.

13. A terminal, comprising a memory and a processor, the memory having a computer program stored thereon which, when read and executed by the processor, causes the processor to perform the web page display method according to claim 1.

14. A computer-readable storage medium having one or more programs stored thereon which, when executed by one or more processors, cause the one or more processors to perform the web page display method according to claim 1.
